(19) United States
(12) Patent Application Publication
(10) Pub. No.: US 2008/0008229 A1
(43) Pub. Date: Jan. 10, 2008

(54) CELLULAR SYSTEM, METHOD OF ALLOCATING FREQUENCY CARRIERS IN THE SYSTEM, BASE STATION CONTROLLER AND BASE STATION USED IN THE SYSTEM

(75) Inventors: Kojiro Hamabe, Tokyo (JP); Yukitsuna Furuya, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/766,303

(22) Filed: Jun. 21, 2007

(30) Foreign Application Priority Data
Jul. 5, 2006 (JP) 2006/185054

(51) Int. Cl. H04B 7/26

(52) U.S. Cl. 375/148; 375/E07.041

(57) ABSTRACT

A cellular system according to an exemplary aspect of the present invention is a cellular system in which a plurality of frequency carriers are available for communication between a base station and a mobile station, including: a first measurement unit for measuring a rate of time that interference power of a frequency carrier in uplink is more than a pre-determined threshold; a carrier availability/unavailability determining unit for putting the frequency carrier into an unavailable state if the time rate is more than a first threshold and putting the frequency carrier into an available state if the time rate is less than a second threshold; and a communication unit for using the frequency carrier in an available state for the communication between the base station and the mobile station.

This application is based upon and claims the benefit of priority from Japanese patent application No. 2006-185054, filed on Jul. 5, 2006, the disclosure of which is incorporated herein in its entirety by reference.

### BACKGROUND OF THE INVENTION

1. Field of the Invention

The present invention relates to a cellular system, a method of allocating frequency carriers in the system, a base station controller and a base station used in the system. Particularly, the present invention relates to dynamic allocation of uplink carriers in a cellular system suitable for uplink packet transmission.

2. Related Art

In a cellular system, the same frequency carrier (hereinafter referred to as a carrier for short) is used in a plurality of cells simultaneously for communication of a large amount of user information between a wireless network including at least a plurality of base stations and multiple mobile stations in one or a plurality of cells formed by each base station.

In such a cellular system, carriers available in the entire cellular system are grouped into, for example, three groups (f1, f2 and f3), as shown in FIG. 9. Carriers in each of the groups are deployed in every three cells so as not to be used simultaneously in neighboring cells, according to a method. In such a method, the same carrier is not used simultaneously in the neighboring cells, avoiding interference with each other.

Moreover, a method is known of measuring interference power of carriers, measuring interference power of carriers available in the entire cellular system by a base station, and deciding an available carrier based on the measurement value and dynamically using the carrier. The method is called a dynamic channel allocation method, described in Japanese Patent Laid-Open No. 04-351126, for example. According to the dynamic channel allocation method, more carriers can be used if there are many carriers not used in surrounding cells compared to a case in which only previously deployed carriers are available. The method has an advantage that carriers can be used more effectively especially when largely different traffic are held in cells.

In this way, a cellular system avoids interference between neighboring cells and repetitively uses the same carrier in many cells to realize a high capacity of traffic.

In packet transmission to transmit data in blocks in uplink, a packet is transmitted in a short time. An average value of the interference power measured during a measurement time longer than the packet transmission time is proportional to the ratio of the packet transmission time to the measurement time to some extent. However, the interference power largely varies depending on positions of a mobile station causing the interference, hence the ratio of the time length to receive the interference cannot be estimated exactly based only on the average value of the interference power.

This results in a propagation loss varying largely between a base station and a mobile station, interference power being extremely large at an instant when the propagation loss is small, an average value of the interference power over the whole measurement time being large even if the ratio of the instant to the whole measurement time is small. For this reason, the measurement value cannot contribute to estimation of a rate of utilization time of a carrier in surrounding cells. Furthermore, it is difficult to avoid a carrier with a high rate of utilization time in other cells to use a carrier with a low rate of utilization time with priority. As a result, there is a problem that interference with other cells will occur frequently, decreasing transmission efficiency.

### BRIEF SUMMARY OF THE INVENTION

In view of the problems in the related art, it is an exemplary object of the present invention to provide a cellular system, a method of allocating frequency carriers in the system, a base station controller and a base station used in the system to efficiently use a carrier in packet transmission.

A cellular system according to an exemplary aspect of the present invention is a cellular system in which a plurality of frequency carriers are available for communication between a base station and a mobile station, including: a first measurement unit for measuring a rate of time that interference power of a frequency carrier in uplink is more than a pre-determined threshold; a carrier availability/unavailability determining unit for putting the frequency carrier into an unavailable state if the time rate is more than a first threshold and putting the frequency carrier into an available state if the time rate is less than a second threshold; and a communication unit for using the frequency carrier in an available state for the communication between the base station and the mobile station.

A carrier allocation method according to an exemplary aspect of the present invention is a frequency carrier allocation method in a cellular system in which a plurality of frequency carriers are available for communication between a base station and a mobile station, including: measuring a rate of time that interference power of a frequency carrier in uplink is more than a pre-determined threshold; putting the frequency carrier into an unavailable state if the time rate is more than a first threshold and putting the frequency carrier into an available state if the time rate is less than a second threshold; and using the frequency carrier in an available state for the communication between the base station and the mobile station.

A base station controller according to an exemplary aspect of the present invention is a base station controller in a cellular system in which a plurality of frequency carriers are available for communication between a base station and a mobile station, including a communication unit for receiving a report of a rate of time from the base station that interference power of a frequency carrier in uplink is more than a pre-determined threshold, and a carrier availability/unavailability determining unit for putting the frequency carrier into an unavailable state if the time rate is more than a first threshold and putting the frequency carrier into an available state if the time rate is less than a second threshold.

A base station according to an exemplary aspect of the present invention is a base station in which a plurality of frequency carriers are available for communication with a mobile station, including: a first measurement unit for measuring a rate of time that interference power of a frequency carrier in uplink is more than a pre-determined threshold; a carrier availability/unavailability determining unit for putting the frequency carrier into an unavailable state if the time rate is more than a first threshold and putting the frequency carrier into an available state if the time rate is less than a second threshold; and a communication unit for using the frequency carrier in an available state for the communication with the mobile station.

A recording medium according to an exemplary aspect of the present invention is a recording medium having recorded thereon a program causing a computer to execute operation of a base station controller in a cellular system in which a plurality of frequency carriers are available for communication between a base station and a mobile station, wherein the program includes processing of receiving a report of a rate of time from the base station that interference power of a frequency carrier in uplink is more than a pre-determined threshold, and processing of putting the frequency carrier into an unavailable state if the time rate is more than a first threshold and putting the frequency carrier into an available state if the time rate is less than a second threshold.

A recording medium according to an exemplary aspect of the present invention is a recording medium having recorded thereon a program causing a computer to execute operation of a base station in which a plurality of frequency carriers are available for communication with a mobile station, wherein the program includes processing of measuring a rate of time that interference power of a frequency carrier in uplink is more than a pre-determined threshold, processing of putting the frequency carrier into an unavailable state if the time rate is more than a first threshold and putting the frequency carrier into an available state if the time rate is less than a second threshold; and processing of using the frequency carrier in an available state for the communication with the mobile station.

A cellular system according to an exemplary aspect of the present invention is a cellular system in which a plurality of frequency carriers are available for communication between a base station and a mobile station, including: first measurement means for measuring a rate of time that interference power of a frequency carrier in uplink is more than a pre-determined threshold; carrier availability/unavailability determining means for putting the frequency carrier into an unavailable state if the time rate is more than a first threshold and putting the frequency carrier into an available state if the time rate is less than a second threshold; and communication means for using the frequency carrier in an available state for the communication between the base station and the mobile station.

A base station controller according to an exemplary aspect of the present invention is a base station controller in a cellular system in which a plurality of frequency carriers are available for communication between a base station and a mobile station, including communication means for receiving a report of a rate of time from the base station that interference power of a frequency carrier in uplink is more than a pre-determined threshold, and carrier availability/unavailability determining means for putting the frequency carrier into an unavailable state if the time rate is more than a first threshold and putting the frequency carrier into an available state if the time rate is less than a second threshold.

A base station according to an exemplary aspect of the present invention is a base station in which a plurality of frequency carriers are available for communication with a mobile station, including: first measurement means for measuring a rate of time that interference power of a frequency carrier in uplink is more than a pre-determined threshold; carrier availability/unavailability determining means for putting the frequency carrier into an unavailable state if the time rate is more than a first threshold and putting the frequency carrier into an available state if the time rate is less than a second threshold; and communication means for using the frequency carrier in an available state for the communication with the mobile station.

### BRIEF DESCRIPTION OF THE DRAWINGS

FIG. 1 illustrates configuration of a cellular system according to first and second embodiments of the invention;

FIG. 2A is a functional block diagram of a base station according to the first and second embodiments, and FIG. 2B is a functional block diagram of a base station controller according to the first and second embodiments;

FIG. 3 is a flow diagram of changing carriers into an unavailable state according to the first and second embodiments;

FIG. 4 is a flow diagram of changing carriers into an available state according to the first and second embodiments;

FIG. 5 illustrates configuration of a cellular system according to third and fourth embodiments of the invention;

FIG. 6 is a functional block diagram of a base station according to the third embodiment;

FIG. 7 is a flow diagram of changing carriers into an unavailable state according to the third and fourth embodiments;

FIG. 8 is a flow diagram of changing carriers into an available state according to the third and fourth embodiments; and

FIG. 9 is a diagram showing an example of carrier allocation in a cellular system.

### DETAILED DESCRIPTION OF EXEMPLARY EMBODIMENTS

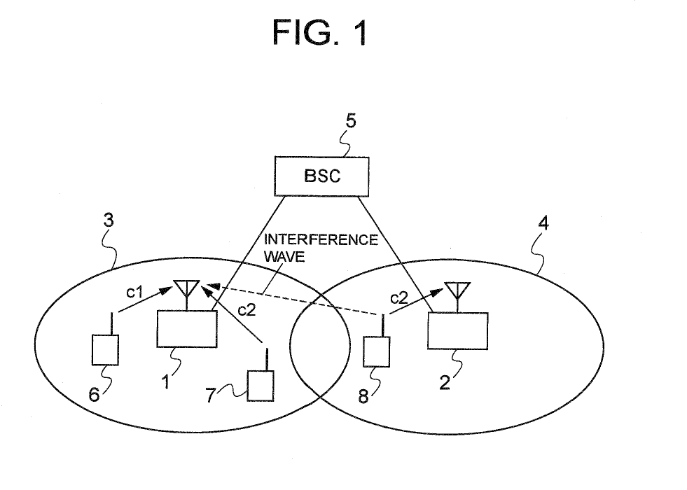

Now, exemplary embodiments of the present invention will be described by referring to the drawings. FIG. 1 illustrates schematic configuration of a cellular system according to a first exemplary embodiment of the present invention. The cellular system comprises a wireless network and mobile stations 6 to 8. The wireless network comprises base stations 1 and 2, cells 3 and 4 covered by the base stations 1 and 2 respectively, and a base station controller (BSC) 5 connecting to the base stations 1 and 2. The cellular system further includes multiple base stations and mobile stations, although not shown for simplicity.

In the cellular system, a plurality of carriers are available for communication between a base station and a mobile station. The carriers include uplink carriers and downlink carriers. Different carriers are used in the Frequency Division Duplexing on uplink and downlink. The OFDM (Orthogonal Frequency Division Multiplexing) is used for modulation.

The carriers are divided in a transmission time unit. In packet transmission from a mobile station to a base station, a carrier is selected, a transmission time is allocated in the transmission time unit, and a data block is transmitted during the transmission time. The base station notifies the mobile station of control information of the selected carrier and the transmission time using a control link set between the base station and the mobile station.

Each data block is attached with an error detection code with which a receiver determines whether or not there is an error in receiving a data block. If there is an error, the receiver transmits a NACK (Non-Acknowledgement) signal to a sender and retains the received data block. Otherwise, if there is no error, the receiver transmits an ACK (Acknowledgement: delivery acknowledgement) signal. If the sender receives the NACK signal, it retransmits the same data block while the receiver combines the retransmitted data block and the retained data block to get a data block to be received. This enables to properly receive a data block in a less number of retransmissions.

Each of the base stations 1 and 2 measures interference power of each carrier used in the cellular system at pre-determined measurement time intervals. Then, each of the base stations 1 and 2 calculates a frequency rate Rintf being a ratio of times that the interference power is more than a pre-determined threshold Tintf of interference power to the number of measurements of the interference power during a pre-determined notification time interval set longer than the measurement time interval. The frequency rate corresponds to a time rate being a ratio of time that the interference power is more than the Tintf to the notification time interval. Each of the base stations 1 and 2 notifies the base station controller 5 of the frequency rate Rintf at notification time intervals. The measurement of the interference power of each carrier can be made while a data block is transmitted on the carrier, but the measurement is made herein while a data block is not transmitted on the carrier.

Each of the base stations 1 and 2 further calculates a retransmission probability Rretx of a data block on each of the carriers used for uplink transmission of the data block at the notification time intervals, and notifies the base station controller 5 of the retransmission probability Rretx and the frequency rate Rintf. The retransmission probability Rretx of a data block is calculated as a value of the times that the base station transmitted a NACK signal to the mobile station divided by the times of transmission of ACK signals and NACK signals. The retransmission probability is also called a communication quality. In this retransmission control, since the same data block may be retransmitted for a number of times, only transmission of a new data block can be accounted into the calculation of a retransmission probability.

Each of the base stations 1 and 2 calculates and notifies the frequency rate Rintf and the retransmission probability Rretx for each cell and each carrier. However, a base station corresponds to a cell herein, so that a calculation for each cell will be described hereinafter as a calculation in a base station corresponding to the cell.

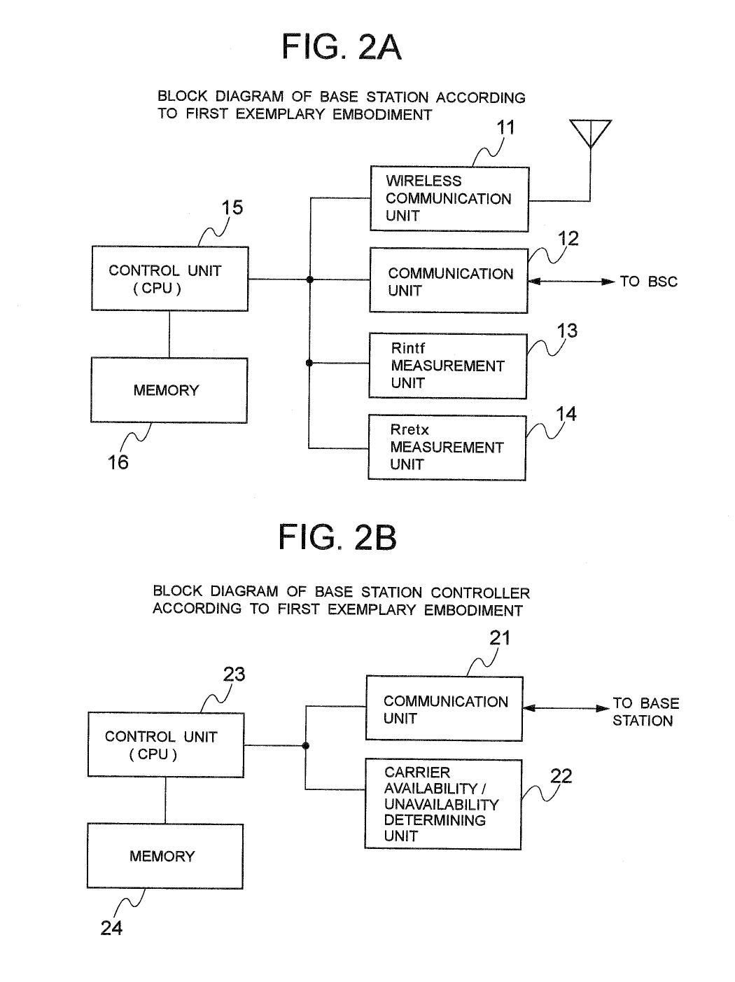

The first exemplary embodiment of the present invention will be described below in detail. In the first exemplary embodiment, the base station controller 5 determines a change between an available state or an unavailable state in all carriers. FIG. 2A is a functional block diagram of a base station according to the first exemplary embodiment and FIG. 2B is a functional block diagram of a base station controller (BSC) according to the first exemplary embodiment.

Referring to FIG. 2A, the base station includes a wireless communication unit 11 for communication with mobile stations, a communication unit 12 for communication with the BSC, an Rintf measurement unit 13 of measuring Rintf, an Rretx measurement unit 14 of measuring Rretx, a control unit (CPU) 15 of controlling these units, and a memory 16 of previously storing a program of a control procedure for the control unit 15.

Referring to FIG. 2B, the base station controller includes a communication unit 21 for communication with the base station, a carrier availability/unavailability determining unit 22 of determining availability/unavailability of carriers, a control unit (CPU) 23 of controlling these units, and a memory 24 of previously storing a program of a control procedure for the control unit 23.

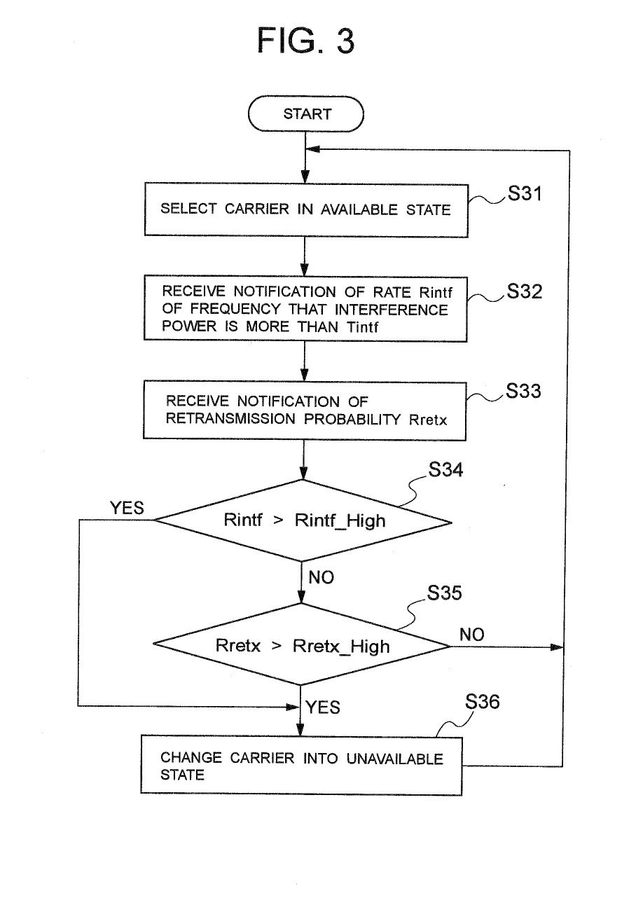

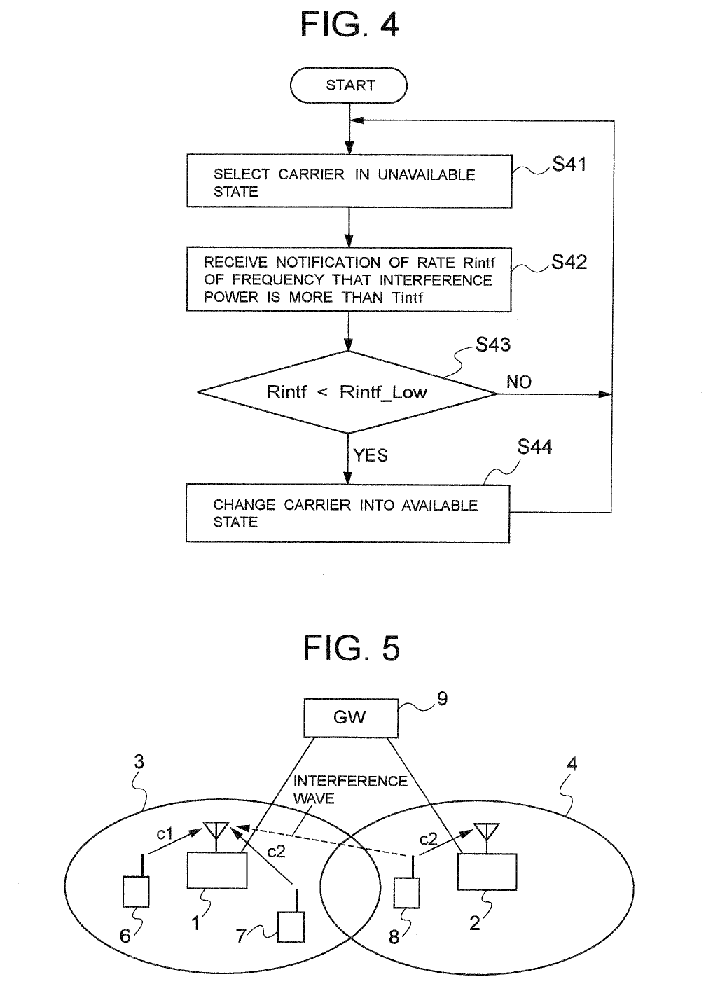

In an initial state of the cellular system at the start-up, all the carriers are in an available state. FIGS. 3 and 4 are a flow diagram to change the carriers into an unavailable state and a flow diagram to change the carriers into an available state, respectively, according to the first exemplary embodiment. The processing of changing is performed by the base station controller for each cell.

Referring to FIG. 3, the base station controller first selects a carrier in an available state (step S31). Then, the controller receives notification of a frequency rate Rintf and a retransmission probability Rretx of the carrier from the base station (steps S32 and S33). Then, if the Rintf is more than a first threshold Rintf_High of the frequency rate, or if the Rretx is more than a threshold Rretx_High of a retransmission probability, then the controller changes the selected carrier into an unavailable state (steps S34, S35 and S36).

Next, referring to FIG. 4, the base station controller selects a carrier in an unavailable state (step S41). Then, the controller receives notification of a frequency rate Rintf of the carrier from the base station (step S42). Then, if the Rintf is less than a second threshold Rintf_Low of a frequency rate, the controller changes the selected carrier into an available state (steps S43 and S44). The second threshold Rintf_Low of a frequency rate is set to a value smaller than the first threshold Rintf_High of a frequency rate.

The base station controller changes an available or unavailable state of each of the carriers and notifies the base station of the information of the change, while the base station updates an available or unavailable state of the carrier based on the notification and uses a carrier in an available state for communication.

An example of the operation of the first exemplary embodiment of the present invention will be described with reference to FIG. 1. In FIG. 1, the mobile stations 6 and 7 in the cell 3 transmit data blocks to the base station 1. The base station 1 measures interference power on a carrier c1. A frequency rate Rintf of the carrier c1 is lower than Rintf_Low since the neighbor cell 4 does not use the carrier c1, hence the carrier c1 is available in the cell 3, i.e. the mobile stations 6 and 7 can use the carrier c1. In FIG. 1, the mobile station 6 uses the carrier c1.

Meanwhile, the base station 1 measures interference power of a carrier c2. The mobile stations 6 and 7 cannot use the carrier c2 if a frequency rate Rintf of the carrier c2 is higher than Rintf_High since the mobile station 8 uses the carrier c2 in the cell 4. If the Rintf is lower than the Rintf_Low, the mobile stations 6 and 7 can use the carrier c2. FIG. 1 shows a state in which the Rintf is lower than the Rintf_Low and the mobile station 7 uses the carrier c2.

Next, a second exemplary embodiment of the present invention will be described. In the second exemplary embodiment, high priority carriers and low priority carriers are defined for each cell. The base station controller determines a change between an available state and an unavailable state only for low priority carriers. Other details are same as the first exemplary embodiment including the configuration diagram of the cellular system in FIG. 1, the functional block diagrams in FIGS. 2A and 2B and the flow diagrams of the operation in FIGS. 3 and 4.

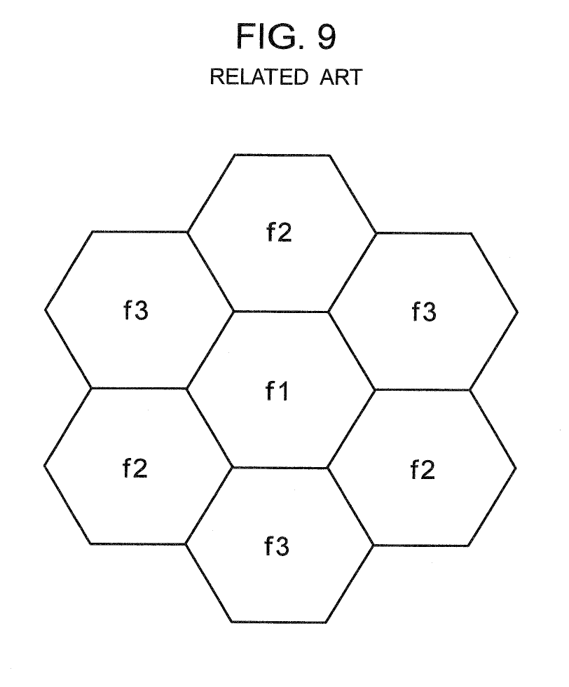

In the second exemplary embodiment, a plurality of carriers available in the entire cellular system are grouped into the carrier groups f1, f2 and f3. The carrier group f1 has a high priority in the cell 3 and the carrier group f2 has a high priority in the cell 4. The carrier group f3 has a high priority in a cell not shown. Carrier groups of high priority are deployed in cells not shown such that different carrier groups have a high priority in neighboring cells as shown in FIG. 9, for example. For each cell, a carrier included in a carrier group of high priority is a carrier of high priority, while a carrier not included in a carrier group of high priority is a carrier of low priority.

In the second exemplary embodiment, carriers of high priority in each cell are always in an available state regardless of the measurement of interference power or a retransmission probability in the base station. On the other hand, an available or unavailable state is determined for carriers of low priority using the same procedure as the first exemplary embodiment.

An example of the operation of the second exemplary embodiment will be described with reference to FIG. 1. In FIG. 1, the carrier c1 belongs to the carrier group f1 and the carrier c2 belongs to the carrier group f2. The base station 1 does not need to measure interference power of the carrier c1 before the mobile stations 6 and 7 can use the carrier c1 since the carrier c1 is a high priority carrier in the cell 3. In FIG. 1, the mobile station 6 uses the carrier c1.

Meanwhile, the base station 1 measures the interference power of the carrier c2 since the carrier c2 is a low priority carrier in the cell 3. The carrier c2 is used by the mobile station 8 in the cell 4; the mobile stations 6 and 7 cannot use the carrier c2 if the frequency rate Rintf is higher than Rintf_High, and the mobile stations 6 and 7 can use the carrier c2 if the Rintf is lower than Rintf_Low. FIG. 1 shows a state in which the Rintf is lower than the Rintf_Low and the mobile station 7 uses the carrier c2.

Next, a third exemplary embodiment of the present invention will be described. In the third exemplary embodiment of the present invention, as shown in a configuration diagram of a cellular system in FIG. 5, the base stations 1 and 2 are connected to a gateway device 9 instead of the base station controller according to the first exemplary embodiment. Each of the base stations 1 and 2 has a function of the base station controller according to the first exemplary embodiment. A wireless network for the cellular system comprises the base stations 1 and 2 and cells 3 and 4 covered by the base stations 1 and 2 respectively.

In the first exemplary embodiment, the base station controller determines an available or unavailable state of the carriers, while in the third exemplary embodiment, the base station determines the state. The other details are same as the first exemplary embodiment.

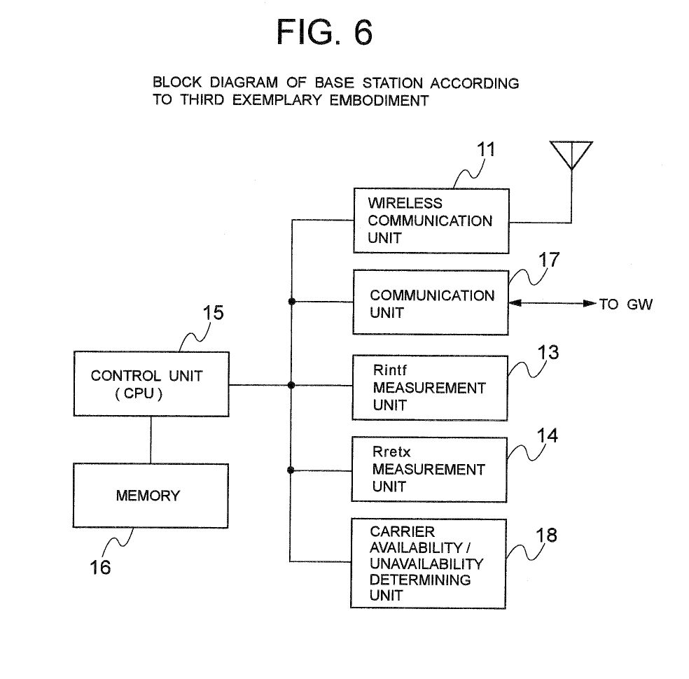

FIG. 6 is a functional block diagram of the base station according to the third exemplary embodiment in which the same parts as in FIG. 2A are given the same reference numerals. The base station includes a wireless communication unit 11, a Rintf measurement unit 13, a Rretx measurement unit 14, a control unit 15, the memory 16 as well as a GW communication unit 17 for communication with the gateway (GW) device 9 and a carrier availability/unavailability determining unit 18 of determining whether a carrier is available or unavailable.

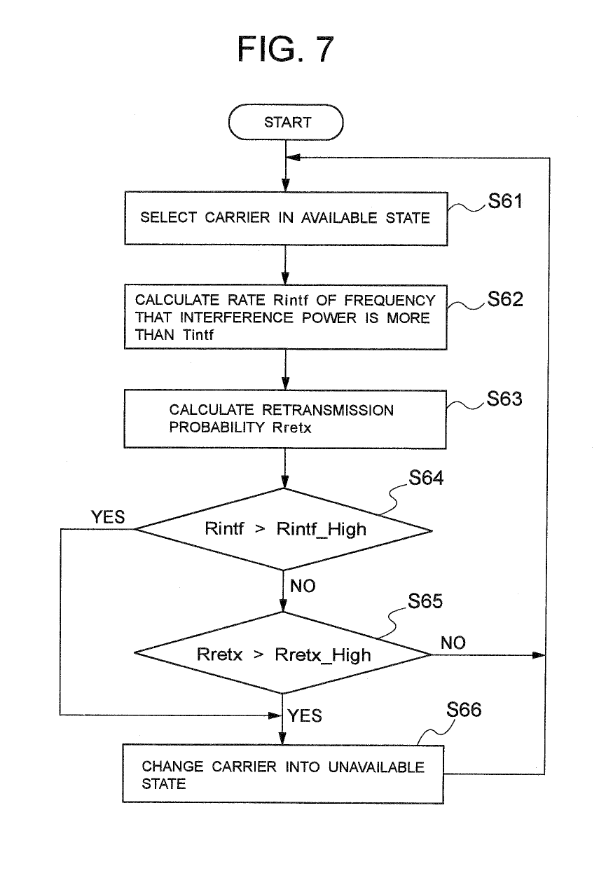

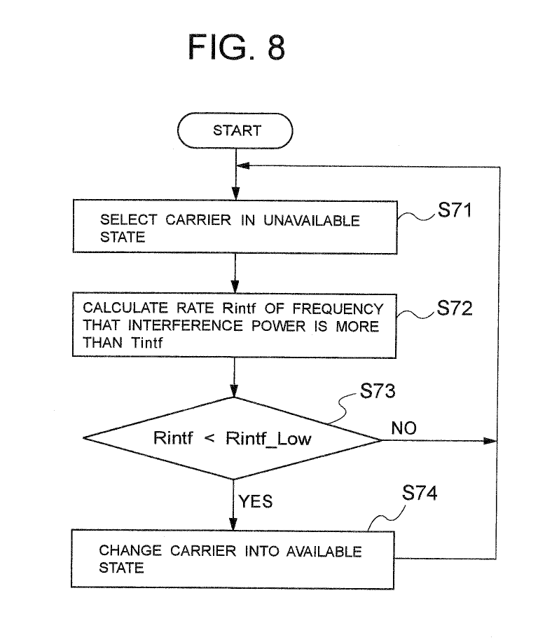

FIGS. 7 and 8 are a flow diagram to change a carrier into an unavailable state and a flow diagram to change a carrier into an available state, respectively, according to the third exemplary embodiment. The processing of changing is performed by the base station for each cell. In this embodiment, each base station has a cell so that the station performs the processing only for the cell.

Referring to FIG. 7, the base station first selects a carrier in an available state (step S61). Then, the base station calculates a frequency rate Rintf and a retransmission probability Rretx of the carrier (steps S62 and S63). Then, if the Rintf is more than a first threshold Rintf_High of the frequency rate, or if the Rretx is more than a threshold Rretx_High of a retransmission probability, then the base station changes the selected carrier into an unavailable state (steps S64, S65 and S66).

Next, referring to FIG. 8, the base station selects a carrier in an unavailable state (step S71). Then, the base station calculates a frequency rate Rintf of the carrier (step S72). Then, if the Rintf is less than a second threshold Rintf_Low of a frequency rate, the base station changes the selected carrier into an available state (steps S73 and S74). The second threshold Rintf_Low of a frequency rate is set to a value smaller than the first threshold Rintf_High of a frequency rate. As described, the base station changes an available or unavailable state of each of the carriers and uses a carrier in an available state for communication.

An example of the operation of the third exemplary embodiment can be described with reference to FIG. 5. Differences between FIG. 1 and FIG. 5 are only the base station controller 5 and the gateway device 9. The example of the operation of the third exemplary embodiment is same as that of the first exemplary embodiment.

Next, a fourth exemplary embodiment of the present invention will be described. In the fourth exemplary embodiment of the present invention, as shown in the configuration diagram of the cellular system in FIG. 5, the base stations are connected to the gateway device instead of the base station controller according to the second exemplary embodiment. Each of the base stations has a function of the base station controller according to the second exemplary embodiment. A wireless network for the cellular system comprises the base stations and cells covered by the base stations.

In the second exemplary embodiment, the base station controller determines an available or unavailable state of the carriers of low priority, while in the fourth exemplary embodiment, the base station determines the state. The other details are same as the second exemplary embodiment. The carriers of low priority are changed between an available and unavailable state similarly to the third exemplary embodiment shown in the flow diagrams in FIGS. 7 and 8.

An example of the operation of the fourth exemplary embodiment can be described with reference to FIG. 5. Differences between FIG. 1 and FIG. 5 are only the base station controller and the gateway device. The example of the operation of the fourth exemplary embodiment is same as that of the second exemplary embodiment.

The operation according to each of the above embodiments can be realized by a program prestored in a recording medium such as an ROM being read and executed by a computer (CPU).

An exemplary advantage according to the invention is that a carrier can be used efficiently in packet transmission by avoiding interference with other cells.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A cellular system wherein a plurality of frequency carriers are available for communication between a base station and a mobile station, comprising:
a first measurement unit for measuring a rate of time that interference power of a frequency carrier in uplink is more than a pre-determined threshold;
a carrier availability/unavailability determining unit for putting said frequency carrier into an unavailable state if said time rate is more than a first threshold and putting said frequency carrier into an available state if said time rate is less than a second threshold; and
a communication unit for using said frequency carrier in an available state for the communication between said base station and said mobile station.

2. The cellular system according to claim 1 wherein said first measurement unit measures said interference power while said frequency carrier is not used for communication.

3. The cellular system according to claim 1 further comprising:
a second measurement unit for measuring quality of the communication while said frequency carrier is used for communication; and wherein
said carrier availability/unavailability determining unit puts said frequency carrier into an unavailable state if said communication quality is less than a pre-determined threshold.

4. The cellular system according to claim 3 wherein said communication includes sending and receiving data blocks, a receiver of the data blocks transmits a delivery acknowledgement to a sender of the data blocks, said sender retransmits the data blocks if said receiver fails to receive said data blocks, and said communication quality corresponds to a probability of retransmission of said data blocks.

5. The cellular system according to claim 1 wherein said plurality of frequency carriers are previously grouped into a first group and a second group with priority lower than the first group, said carrier availability/unavailability determining unit determines an available/unavailable state of frequency carriers in said second group.

6. A frequency carrier allocation method in a cellular system wherein a plurality of frequency carriers are available for communication between a base station and a mobile station, comprising:
measuring a rate of time that interference power of a frequency carrier in uplink is more than a pre-determined threshold;
putting said frequency carrier into an unavailable state if said time rate is more than a first threshold and putting said frequency carrier into an available state if said time rate is less than a second threshold; and
using said frequency carrier in an available state for the communication between said base station and said mobile station.

7. The frequency carrier allocation method according to claim 6 wherein said interference power is measured while said frequency carrier is not used for communication.

8. The frequency carrier allocation method according to claim 6 further comprising:
measuring quality of the communication while said frequency carrier is used for communication; and
putting said frequency carrier into an unavailable state if said communication quality is less than a pre-determined threshold.

9. The frequency carrier allocation method according to claim 8 wherein said communication includes sending and receiving data blocks, a receiver of the data blocks transmits a delivery acknowledgement to a sender of the data blocks, said sender retransmits the data blocks if said receiver fails to receive said data blocks, and said communication quality corresponds to a probability of retransmission of said data blocks.

10. The frequency carrier allocation method according to claim 6 wherein said plurality of frequency carriers are previously grouped into a first group and a second group with priority lower than the first group, the cellular system determines an available/unavailable state of frequency carriers in said second group.

11. A base station controller in a cellular system wherein a plurality of frequency carriers are available for communication between a base station and a mobile station, comprising:
a communication unit for receiving a report of a rate of time from said base station that interference power of a frequency carrier in uplink is more than a pre-determined threshold; and
a carrier availability/unavailability determining unit for putting said frequency carrier into an unavailable state if said time rate is more than a first threshold and putting said frequency carrier into an available state if said time rate is less than a second threshold.

12. The base station controller according to claim 11 wherein said communication unit receives a report of quality of the communication measured by said base station while said base station uses said frequency carrier for communication, and said carrier availability/unavailability determining unit puts said frequency carrier into an unavailable state if said communication quality is less than a pre-determined threshold.

13. The base station controller according to claim 12 wherein said communication includes sending and receiving data blocks, a receiver of the data blocks transmits a delivery acknowledgement to a sender of the data blocks, said sender retransmits the data blocks if said receiver fails to receive said data blocks, and said communication quality corresponds to a probability of retransmission of said data blocks.

14. The base station controller according to claim 11 wherein said plurality of frequency carriers are previously grouped into a first group and a second group with priority lower than the first group, said carrier availability/unavailability determining unit determines an available/unavailable state of frequency carriers in said second group.

15. A base station wherein a plurality of frequency carriers are available for communication with a mobile station, comprising:
a first measurement unit for measuring a rate of time that interference power of a frequency carrier in uplink is more than a pre-determined threshold;
a carrier availability/unavailability determining unit for putting said frequency carrier into an unavailable state if said time rate is more than a first threshold and putting said frequency carrier into an available state if said time rate is less than a second threshold; and
a communication unit for using said frequency carrier in an available state for the communication with said mobile station.

16. The base station according to claim 15 wherein said first measurement unit measures said interference power while said frequency carrier is not used for communication.

17. The base station according to claim 15 further comprising:
a second measurement unit for measuring quality of the communication while said frequency carrier is used for communication; and wherein
said carrier availability/unavailability determining unit puts said frequency carrier into an unavailable state if said communication quality is less than a pre-determined threshold.

18. The base station according to claim 17 wherein said communication includes sending and receiving data blocks, a receiver of the data blocks transmits a delivery acknowledgement to a sender of the data blocks, said sender retransmits the data blocks if said receiver fails to receive said data blocks, and said communication quality corresponds to a probability of retransmission of said data blocks.

19. The base station according to claim 15 wherein said plurality of frequency carriers are previously grouped into a first group and a second group with priority lower than the first group, said carrier availability/unavailability determining unit determines an available/unavailable state of frequency carriers in said second group.

20. A recording medium having recorded thereon a program causing a computer to execute operation of a base station controller in a cellular system wherein a plurality of frequency carriers are available for communication between a base station and a mobile station, wherein
the program comprises processing of receiving a report of a rate of time from said base station that interference power of a frequency carrier in uplink is more than a pre-determined threshold, and processing of putting said frequency carrier into an unavailable state if said time rate is more than a first threshold and putting said frequency carrier into an available state if said time rate is less than a second threshold.

21. A recording medium having recorded thereon a program causing a computer to execute operation of a base station wherein a plurality of frequency carriers are available for communication with a mobile station, wherein
the program comprises processing of measuring a rate of time that interference power of a frequency carrier in uplink is more than a pre-determined threshold,
processing of putting said frequency carrier into an unavailable state if said time rate is more than a first threshold and putting said frequency carrier into an available state if said time rate is less than a second threshold; and
processing of using said frequency carrier in an available state for the communication with said mobile station.

22. A cellular system wherein a plurality of frequency carriers are available for communication between a base station and a mobile station, comprising:
first measurement means for measuring a rate of time that interference power of a frequency carrier in uplink is more than a pre-determined threshold;
carrier availability/unavailability determining means for putting said frequency carrier into an unavailable state if said time rate is more than a first threshold and putting said frequency carrier into an available state if said time rate is less than a second threshold; and
communication means for using said frequency carrier in an available state for the communication between said base station and said mobile station.

23. A base station controller in a cellular system wherein a plurality of frequency carriers are available for communication between a base station and a mobile station, comprising:
communication means for receiving a report of a rate of time from said base station that interference power of a frequency carrier in uplink is more than a pre-determined threshold; and
carrier availability/unavailability determining means for putting said frequency carrier into an unavailable state if said time rate is more than a first threshold and putting said frequency carrier into an available state if said time rate is less than a second threshold.

24. A base station wherein a plurality of frequency carriers are available for communication with a mobile station, comprising:
first measurement means for measuring a rate of time that interference power of a frequency carrier in uplink is more than a pre-determined threshold;
carrier availability/unavailability determining means for putting said frequency carrier into an unavailable state if said time rate is more than a first threshold and putting said frequency carrier into an available state if said time rate is less than a second threshold; and
communication means for using said frequency carrier in an available state for the communication with said mobile station.
